(19) United States
(12) Patent Application Publication
(10) Pub. No.: US 2021/0232195 A1
(43) Pub. Date: Jul. 29, 2021

(54) SYSTEMS AND METHODS FOR COMMUNICATING POWER EVENT OF DISPLAY DEVICE COUPLED TO INFORMATION HANDLING SYSTEM

(71) Applicant: Dell Products L.P., Round Rock, TX (US)

(72) Inventors: Cyril A. KEILERS, Georgetown, TX (US); Shawn P. HOSS, Georgetown, TX (US); Chris M. HELBERG, Austin, TX (US); David G. METHVEN, Austin, TX (US)

(73) Assignee: Dell Products L.P., Round Rock, TX (US)

(21) Appl. No.: 16/775,522

(22) Filed: Jan. 29, 2020

(51) Int. Cl. G06F 1/26; G06F 13/20; G06F 13/42; G06F 11/30; G06F 11/34

(52) U.S. Cl. CPC G06F 1/26; G06F 13/20; G06F 13/4282; G06F 2213/0042; G06F 11/3058; G06F 11/3438; G06F 11/302

(57) ABSTRACT

A system may include an input for receiving a stimulus to modify a power state of the system and a controller configured to monitor for user interaction with the input and in response to user interaction with the input, communicate a message via a vendor-defined message over a communications interface to a second controller integral to an information handling system, wherein such second controller is configured to replicate the message to a management controller integral to the information handling system to cause the management controller to change a power state of the information handling system.

### TECHNICAL FIELD

The present disclosure relates in general to information handling systems, and more particularly to methods and systems for communicating a power event, such as a user interaction with a power button, from a display device to an information handling system coupled to the display device.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In traditional implementations, a display device's power state may be maintained separately from an information handling system to which it is coupled. Thus, turning a display device on or off (e.g., by interacting with a power button) does not cause an information handling system to which it is coupled to turn on or off as well. However, in some form factors of information handling systems, accessibility of a power button may be physically difficult for a user. Accordingly, it may be desirable to provide users with an ability to power down an information handling system having a difficult-to-reach power button by interacting with a power button of a display device coupled to the information handling system.

### SUMMARY

In accordance with the teachings of the present disclosure, the disadvantages and problems associated with powering on and off information handling systems and coupled display devices may be reduced or eliminated.

In accordance with embodiments of the present disclosure, a system may include an input for receiving a stimulus to modify a power state of the system and a controller configured to monitor for user interaction with the input and in response to user interaction with the input, communicate a message via a vendor-defined message over a communications interface to a second controller integral to an information handling system, wherein such second controller is configured to replicate the message to a management controller integral to the information handling system to cause the management controller to change a power state of the information handling system.

In accordance with these and other embodiments of the present disclosure, a method may include monitoring, with a controller, for user interaction with an input for receiving a stimulus to modify a power state of a system and in response to user interaction with the input, communicating a message via a vendor-defined message over a communications interface to a second controller integral to an information handling system, wherein such second controller is configured to replicate the message to a management controller integral to the information handling system to cause the management controller to change a power state of the information handling system.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to monitor, with a controller, for user interaction with an input for receiving a stimulus to modify a power state of a system and in response to user interaction with the input, communicate a message via a vendor-defined message over a communications interface to a second controller integral to an information handling system, wherein such second controller is configured to replicate the message to a management controller integral to the information handling system to cause the management controller to change a power state of the information handling system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system comprising an information handling system and a display device, in accordance with embodiments of the present disclosure; and

FIG. 2 illustrates a flow chart of an example method for communicating a power event, such as a user interaction with a power button, from a display device to an information handling system coupled to the display device, in accordance with embodiments of the present disclosure.

### DETAILED DESCRIPTION

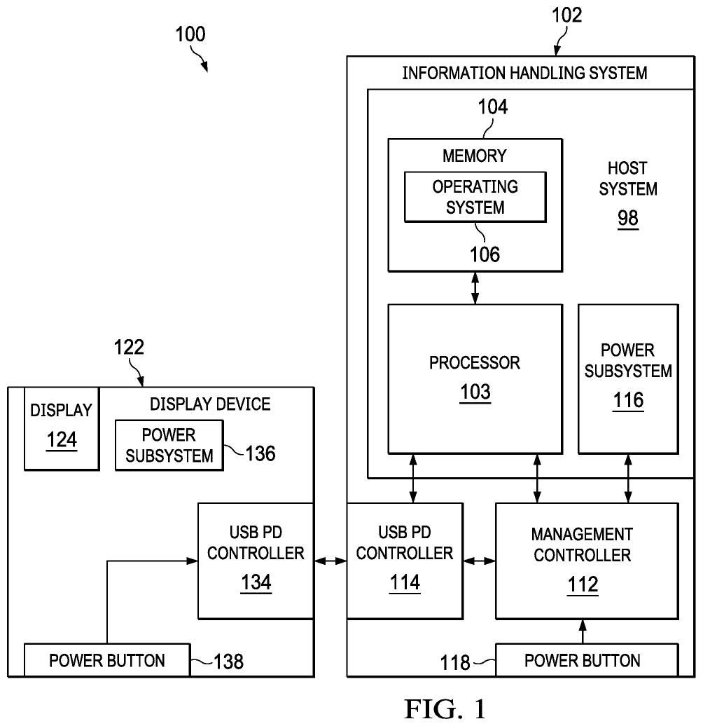

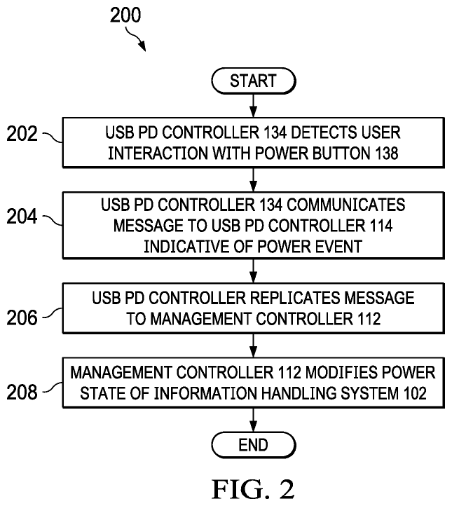

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example system 100 comprising an information handling system 102 and a display device 122, in accordance with embodiments of the present disclosure. In some embodiments, information handling system 102 may comprise a personal computer. In some embodiments, information handling system 102 may comprise or be an integral part of a server. In other embodiments, information handling system 102 may comprise a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a management controller 112 communicatively coupled to processor 103, a Universal Serial Bus (USB) Power Delivery (PD) controller 114 communicatively coupled to processor 103 and management controller 112, a power subsystem 116 communicatively coupled to management controller 112, and a power button 118 communicatively coupled to management controller 112. In operation, processor 103 and memory 104 may comprise at least a portion of a host system 98 of information handling system 102.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. Active portions of operating system 106 may be transferred to memory 104 for execution by processor 103. Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Management controller 112 may be configured to provide management facilities for management of information handling system 102. Such management may be made by management controller 112 even if information handling system 102 is powered off or powered to a standby state. Management controller 112 may include a processor, a memory, and or other components, such as USB PD controller 114. In certain embodiments, management controller 112 may include or may be an integral part of an embedded controller (EC), baseboard management controller (BMC), or a remote access controller (e.g., a Dell Remote Access Controller or Integrated Dell Remote Access Controller).

USB PD controller 114 may comprise any suitable system, device, or apparatus configured to control communication of signals in accordance with the USB PD specification.

Power subsystem 116 may comprise any suitable system, device, or apparatus configured to deliver electrical energy to one or more components of information handling system 102 in order to allow such components to function. Accordingly, power subsystem 116 may include any suitable combination and numbers of power supply units, energy storage devices (e.g., batteries), regulators, and electrical conduits (e.g., wires, traces).

Power button 118 may comprise any suitable system, device, or apparatus with which a user may interact to indicate a desire to power on or power off information handling system 102. Accordingly, power button 118 may comprise an electromechanical button, a virtual mechanical button, or any other suitable device.

In addition to processor 103, memory 104, and management controller 112, USB PD controller 114, power subsystem 116, and power button 118, information handling system 102 may include one or more other information handling resources. In addition, although FIG. 1 shows information handling system 102 configured as what many would consider a computing system, in some embodiments, information handling system 102 may include fewer components than that often seen in a computing system, and may comprise a device with less functionality, such as a docking station or port replicator.

As depicted in FIG. 1, display device 122 may include a display 124, a USB PD controller 134, a power subsystem 136, and a power button 138 communicatively coupled to USB PD controller 134.

Display 124 may include any system, device, or apparatus configured to generate graphical images and/or reproduce alphanumeric text for viewing by a user of information handling system 102, based on display data communicated to display 124 from information handling system 102. Display 124 may comprise a light-emitting diode display, liquid crystal display, and/or any other suitable display.

USB PD controller 134 may comprise any suitable system, device, or apparatus configured to control communication of signals in accordance with the USB PD specification. In operation, USB PD controller 134 may be coupled to USB PD controller 114 by a suitable cable (e.g., a USB Type-C cable).

Power subsystem 136 may comprise any suitable system, device, or apparatus configured to deliver electrical energy to one or more components of display device 122 in order to allow such components to function. Accordingly, power subsystem 136 may include any suitable combination and number of power supply units, energy storage devices (e.g., batteries), regulators, and electrical conduits (e.g., wires, traces).

Power button 138 may comprise any suitable system, device, or apparatus with which a user may interact to indicate a desire to power on or power off display device 122. Accordingly, power button 138 may comprise an electromechanical button, a virtual mechanical button, or any other suitable device.

For clarity of exposition, FIG. 1 depicts only a single display device 122 communicatively coupled to information handling system 102. However, in some embodiments of system 100, system 100 may include a plurality of display devices 122 communicatively coupled to information handling system 102 (e.g., directly to information handling system 102 or in a daisy chain from display device 122 to display device 122).

As described in greater detail below, USB PD controller 114 and USB PD controller 134 may utilize a vendor-defined messaging (VDM) capability of USB-C/Type-C to communicate via configuration channel (CC) pins of a USB PD connection between display device 122 and information handling system 102. Accordingly, display device 122 may be configured to communicate a power event, such as a user interaction with power button 138, to information handling system 102, and such power button signal may be replicated at information handling system 102 to power down information handling system 102.

FIG. 2 illustrates a flow chart of an example method 200 for communicating a power event, such as a user interaction with a power button, from a display device to an information handling system coupled to the display device, in accordance with embodiments of the present disclosure.

According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, USB PD controller 134 may detect, for example via a general purpose input/output (GPIO) interface or Inter-Integrated Circuit (I2C) interface with power button 138, a user interaction (e.g., a button press) with power button 138 or another stimulus for modifying a power state of display device 122. At step 204, USB PD controller 134 may communicate (e.g., via a vendor-defined message and/or alternate mode application communicated over configuration channel (CC) pins of the USB PD connection between USB PD controller 134 and USB PD controller 114), a message to USB PD controller 114 indicative of the power event.

At step 206, USB PD controller 114 may receive the message indicative of the power event and replicate the message (e.g., via a GPIO interface or I2C interface with management controller 112) to management controller 112, thus emulating to management controller 112 a user interaction with power button 118. At step 208, responsive to the replicated messages, management controller 112 may modify a power state (e.g., power on or power off) of information handling system 102. After completion of step 208, method 200 may end.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using display device 122 and/or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A system comprising:
an input for receiving a stimulus to modify a power state of the system; and
a controller configured to:
monitor for user interaction with the input; and
in response to user interaction with the input, communicate a message via a vendor-defined message over a communications interface to a second controller integral to an information handling system, wherein such second controller is configured to replicate the message to a management controller integral to the information handling system to cause the management controller to change a power state of the information handling system.

2. The system of claim 1, wherein the system is a display device communicatively coupled to the information handling system.

3. The system of claim 1, wherein the communications interface comprises configuration channel pins of a Universal Serial Bus Power Delivery interface between the system and the information handling system.

4. The system of claim 3, wherein:
the controller comprises a first Universal Serial Bus Power Delivery controller; and
the second controller comprises a second Universal Serial Bus Power Delivery controller.

5. The system of claim 1, wherein the input is a power button.

6. A method comprising:
monitoring, with a controller, for user interaction with an input for receiving a stimulus to modify a power state of a system; and
in response to user interaction with the input, communicating a message via a vendor-defined message over a communications interface to a second controller integral to an information handling system, wherein such second controller is configured to replicate the message to a management controller integral to the information handling system to cause the management controller to change a power state of the information handling system.

7. The method of claim 6, wherein the system is a display device communicatively coupled to the information handling system.

8. The method of claim 6, wherein the communications interface comprises configuration channel pins of a Universal Serial Bus Power Delivery interface between the system and the information handling system.

9. The method of claim 8, wherein:
the controller comprises a first Universal Serial Bus Power Delivery controller; and
the second controller comprises a second Universal Serial Bus Power Delivery controller.

10. The method of claim 6, wherein the input is a power button.

11. An article of manufacture comprising:
a non-transitory computer-readable medium; and
computer-executable instructions carried on the computer-readable medium, the instructions readable by a processor, the instructions, when read and executed, for causing the processor to:
monitor, with a controller, for user interaction with an input for receiving a stimulus to modify a power state of a system; and
in response to user interaction with the input, communicate a message via a vendor-defined message over a communications interface to a second controller integral to an information handling system, wherein such second controller is configured to replicate the message to a management controller integral to the information handling system to cause the management controller to change a power state of the information handling system.

12. The article of claim 11, wherein the system is a display device communicatively coupled to the information handling system.

13. The article of claim 11, wherein the communications interface comprises configuration channel pins of a Universal Serial Bus Power Delivery interface between the system and the information handling system.

14. The article of claim 13, wherein:
the controller comprises a first Universal Serial Bus Power Delivery controller; and
the second controller comprises a second Universal Serial Bus Power Delivery controller.

15. The article of claim 11, wherein the input is a power button.
